(19) United States
(12) Patent Application Publication
(10) Pub. No.: US 2010/0136334 A1
(43) Pub. Date: Jun. 3, 2010

(54) Fire Retardant Thread and Method of Manufacture

(75) Inventor: Yehezkiel Gotshal, Ramat Gan (IL)

Correspondence Address: LERNER GREENBERG STEMER LLP, P O BOX 2480, HOLLYWOOD, FL, 33022-2480, US

(73) Assignee: Israeli Processing Co., Ltd., Yavne (IL)

(21) Appl. No.: 12/326,499

(22) Filed: Dec. 2, 2008

(51) Int. Cl. B32B 27/34; B32B 27/36; B32B 27/32; B32B 27/12

(52) U.S. Cl. 428/395; 428/394; 442/136

(57) ABSTRACT

The present invention is a fire retardant sewing thread, having a coating of a brominated acrylic copolymer and a non ionic surfactant or a bromine or phosphorus based flame retardant and an adhesive and a process for making the fire retardant thread.

### BACKGROUND OF THE INVENTION

### Field of the Invention

Significant progress has been made in the development of fire retardant (FR) fabrics and fabric containing products. The two major strategies for achieving the desired performance are, first, the use of specialized fibers composed of polymers or minerals which are inherently resistant to ignition and, second, the treatment of conventional fibers with chemical finishes which retard burning by interfering with the combustion cycle.

Textile based end-use products are customarily assembled using sewing technologies whereby a sewing thread alternately penetrates adjoining fabric parts and consequently connects them. In many fire scenarios, despite the use of fire retardant fabrics, ignition and failure of the sewing thread leads to serious consequences due to the article falling apart and exposing underlying layers to harm.

### SUMMARY OF THE INVENTION

The purpose of the present disclosure is to teach a method and process for rendering conventional polyester, nylon, polyolefin or cotton sewing thread fire retardant while maintaining the requisite properties of a high speed sewing thread.

Inherently, FR fibers are widely used for production of FR thread. These include threads formed of polyaramids, novoloid, phenolic, polyamide-imide, polybenzimidazole, FR polyester, FR rayon, glass and mineral fibers. However, these fibers have significant drawbacks including high production energy footprint, high price, limited pliability, rough surface, unsuitable mechanical properties, limited dyeability, inappropriate melting and shrinkage, atopic reaction, severe yellowing, poor light stability, and often require special sewing equipment. Attempts have been made to impart FR properties to conventional sewing threads of cotton, nylon, polyolefin or polyester fiber, using FR finishes. The FR agents are typically phosphorous and bromine based chemicals which are dispersed in a liquid medium and coated onto the thread. Unfortunately, the resulting thread is generally unsatisfactory due to several factors, including FR agent particles significantly dusting off the thread as it traverses the eye of a sewing needle, increased friction, a whitish cast, considerably increased stiffness, variations in thread diameter and unsatisfactory fire retardation. The main reason for the unsatisfactory FR performance is the need to use significant amounts of flammable acrylic, polyurethane, vinyl acetate, etc. binder to fix the FR chemicals onto the fibers of the thread, creating additional combustible material burden.

In one embodiment of the current invention, the aforementioned fire retardant agents are replaced with a brominated polymeric acrylic FR binder. The FR binder thinly and evenly coats the polyester, nylon, polyolefin, or cotton thread, is non dusting, has little affect on the shade of the thread and does not significantly affect thread sewing performance. Once cured at least 140° degrees centigrade for at least 4 seconds. The FR finish is fast to laundry, crocking, soaking, perspiration, and repeated flexing. Dry add-on of said finish can range from 3 to 80% of the weight of the untreated thread.

The treated thread according to the present invention does not adversely affect the flame retardant nature of an assembled mattress. When used to sew together a mattress, the thread treated according to the present invention, does not cause a failure of the assembled mattress when tested according to a standardized open flame resistant test such as The California Bureau of Home Furnishings and Thermal Insulation Technical Bulletin 603, requiring all mattresses, box springs, futons and foundations manufactured and sold in the state of California to be open flame resistant.

In a further embodiment of this invention, the treated thread is dipped into an aqueous bath containing a dispersion of the aforementioned brominated polymeric acrylic binder and is subsequently squeezed and cured in an oven.

In a further embodiment of this invention, synergists and insoluble phosphorous containing salts are added to the aforementioned FR binder. Said additives are fixed to the thread by the brominated polymeric acrylic FR binder.

In a further embodiment of this invention, the treated thread is dyed prior to treatment.

In a further embodiment of this invention, the treated thread is dipped into a solvent bath containing a solution of bromine or phosphorus based FR agents and a suitable binder and said thread is subsequently squeezed and the solvent is evaporated in an oven, leaving a coating of fixed FR agent on the fibers of said thread. Said bromine or phosphorus based FR agents may include Tetrabromobisphenol A (TBBA), Ammonium polyphosphate and Hexabromocyclododecane. Said solvent bath may include methanol, ethanol, isopropanol, n-propanol, n-butanol, combinations thereof, and the like. Suitable solvents may also include secondary alcohols, tertiary alcohols, esters thereof, mixtures thereof, and the like.

In a further embodiment of this invention, synergists are added to the aforementioned solvent bath. Said additives are fixed to the thread by the aforementioned solvent soluble binder.

### BRIEF DESCRIPTION OF THE SEVERAL VIEWS OF THE DRAWING

FIG. 1 is a graph showing test results of heat release rate over time and a table detailing total heat released in the test for sample A mattress.

FIG. 2 is a graph showing test results of heat release rate over time and a table detailing total heat released in the test for sample B mattress.

### DETAILED DESCRIPTION OF THE INVENTION

The present invention relates to a FR thread and a method of manufacture. Preferred materials are brominated polymeric acrylic or vinyl acetate binders like the TexFRon® product available from ICL-IP (Beer-Sheva, Israel).

Also preferred are poly brominated aromatic and aliphatic compounds such as FR 9020, FR 720, FR 1524 available from ICL-IP (Beer-Sheva, Israel), as well as phosphorous containing insoluble salts such as ammonium polyphosphates and others.

The Flame retardant (FR) is dispersed in water or organic solvents. Suitable solvents include, but are not limited to primary, secondary, and tertiary alcohols, esters, linear and cyclic hydrocarbons, halogenated hydrocarbons and phenyl type solvents.

The aqueous and non aqueous solvents also include polymeric adhesives intended to promote adhesion of the coating to specific fibers including polyamide, polyester and polyolefin as well as other additives intended to improve the friction properties, pliability, inter-filament cohesion, and appearance of the finished thread.

In a preferred embodiment the method of manufacture includes the following steps:

TexFRon® or other FR is diluted in water or solvents to a range of 50 to 5% solids;

a non ionic wetting agent is added at a concentration range of 0.1 to 5% by weight;

thickening agents such as acrylic acid derivatives or polysaccharide derivatives are added as needed to obtain a viscosity range of 20 to 2,000 cps. Other additives (pigments, lubricants, adhesives, softeners, fillers, etc.) are added as needed;

Polyester, polyolefin or polyamide thread is dipped in the FR formulation and squeezed to a wet pick up ranging from 20 to 250% based upon the weight of the thread;

Thread is passed through drying and curing ovens set at 80° C. to 180° C. and 110° C. to 260° C. respectively; and

thread is wound on bobbins.

In preferred embodiments, synergists and salts are added as needed to enhance FR performance and provide anti-smoldering properties, respectively.

Synergists include, but are not limited to elemental base metals and compounds containing antimony, tin, boron, zinc and aluminum oxides and salts and insoluble phosphorous containing salts including ammonium polyphosphates.

The synergists and salts are present in the range of 1 to 15% based on the weight of the thread.

The formulation of the present invention is particularly suitable for obtaining good coverage and adhesion on smooth sewing thread. At the same time, the formulation produces a sufficient add-on (2 to 50% on dry weight of thread) of the FR agent to impart flame retardancy that will pass severe test standards such as TB 603 and Consumer Product Safety Commission 16 CFR Part 1633.

An additional advantage of the thread is the process by which the final thread is manufactured. The process is continuous and not batchwise. In order to arrive at the final FR thread of the present invention, several modifications were needed to be investigated to arrive at a FR thread that meets both the required safety tests and will be suitable for use on a manufacturing level. AS stated above, many FR threads are unsuitable due to large quantities of FR agent particles dusting off the thread as it traverses the eye of a sewing needle, increased friction, a whitish cast, increased stiffness, variations in thread diameter and unsatisfactory fire retardation. The thread of the present invention required selection of appropriate FR agents that do not require large amounts of adhesive resin to adhere to the thread yet provide adhesion good enough to withstand the abrasion that sewing thread undergoes as it traverses through the sewing machine guides, tension discs, sewing needle and fabric. It is also important to obtain the appropriate rheological properties in the formulation that will create a homogeneous, continuous and thin coating on the thread and refrain from causing adjacent threads from clumping and sticking to each other. The desired finished FR thread will be able to obtain specific dipping, drying and curing properties that will allow continuous processing at high speeds (above 10 meter/minute) which would be suitable for manufacturing FR polyester, polyolefin and polyamide thread.

The following examples are illustrative and are not intended to limit the scope of the invention.

### EXAMPLE 1

10 grams of a nonionic surfactant (Triton X100, Dow Chemical Co., Midland Mich.) are slowly mixed with 3 liters of deionized water which are subsequently slowly added to 2 liters of TexFRon® 45S (ICL-IP) while stirring mechanically at 800-1000 RPM. Stirring is continued for 10 minutes. pH is adjusted to between 6 and 8 using ammonia solution (10% concentration by weight). 7.5 grams of a polyacrylate thickener (Carbopol® 934 (The Lubrizol Corporation, Wickliffe, Ohio) are added to adjust viscosity to about 2000 cPs.

### EXAMPLE 2

To the formulation of Example 1, 100 grams of a fluorocarbon (Scotchgard®, 3M, Hutchison Minn.) are added and the formulation is stirred with a mechanical mixer at 1000 RPM for 10 minutes.

### EXAMPLE 3

To the formulation of Example 1, 100 grams of a polyethylene wax emulsion (Liquilube® 418, The Lubrizol Corporation, Wickliffe, Ohio) are added and the formulation is stirred at 1000 RPM for 10 minutes.

### EXAMPLE 4

To the formulation of Example 1, 230 grams of antimony pentoxide (Nyacol® A1550, Nyacol Nano Technologies, Inc., Ashland, Mass.) are added and the formulation is stirred at 1000 RPM for 10 minutes.

### EXAMPLE 5

To the formulation of Example 1, 100 grams of ammonium polyphosphate (ICL-IP) are added and the formulation is stirred at 1000 RPM for 10 minutes.

### EXAMPLE 6

To the formulation of Example 1, 1,500 grams of a polyamide adhesive emulsion (Rayobond BPA, Dr. Th. Boehme Chemie & Service, Deretsfried, Del.) are added and the formulation is stirred at 1000 RPM for 30 minutes.

### EXAMPLE 7

The formulation of Example 1 is poured into the heated trough (45° C.) of a 3 bowl padding mangle. Polyester thread is continuously fed into the trough and is squeezed at about 1.2 bar. The thread is then transported to a drying oven operating at about 120° C. and subsequently to a curing oven operating at 180° C. Upon exit, the thread is coated with a waxy emulsion. A preferred emulsion is a polyethylene wax emulsion (Liquilube® 418, The Lubrizol Corporation, Wickliffe).

The emulsion is applied using a Lick roll. The thread is then wound on a bobbin.

The process of Example 7 may be performed with the formulations of Examples 2-5 and combinations thereof.

### EXAMPLE 8

The formulation of Example 6 is poured into the heated trough (45° C.) of a 3 bowl padding mangle. Nylon thread is continuously fed into the trough and is squeezed at about 1.2 bar. The thread is then transported to a drying oven operating at about 120° C. and subsequently to a curing oven operating at 180° C. Upon exit, the thread is coated with a waxy emulsion using a kiss roll. The thread is then wound on a bobbin.

### EXAMPLE 9

15 grams of a cationic surfactant (trimethyl stearyl ammonium chloride, Sigma-Aldrich, St. Louis, Mo.) are slowly mixed with 4 liters of a 30:70 blend of ethanol and methanol containing a proprietary polyamide adhesive, to which are subsequently slowly added 1,200 grams of Tetrabromobisphenol A (ICL-IP) while stirring mechanically at 800-1000RPM. Stirring is continued for 10 minutes. The pH is adjusted to between 6 and 8 using acetic acid solution (12% concentration by weight). 7.5 grams of a polyacrylate thickener (Carbopol® 934) are added to adjust viscosity to about 2000 cPs.

### EXAMPLE 10

To the formulation of Example 9, 100 grams of a fluorocarbon (Scotchgard®, 3M) are added and the formulation is stirred at 1000 RPM for 10 minutes.

### EXAMPLE 11

To the formulation of Example 9, 100 grams of a polyethylene wax emulsion (Liquilube® 418, The Lubrizol Corporation, Wickliffe, Ohio) are added and the formulation is stirred at 1000 RPM for 10 minutes.

### EXAMPLE 12

To the formulation of Example 9, 210 grams of antimony pentoxide (Nyacol® A1550, Nyacol Nano Technologies, Inc., Ashland, Mass.) are added and the formulation is stirred at 1000 RPM for 10 minutes.

### EXAMPLE 13

To the formulation of Example 9, 100 grams of ammonium polyphosphate (ICL-IP) are added and the formulation is stirred at 1000 RPM for 10 minutes.

### EXAMPLE 14

To the formulation of Example 9, 600 grams of a proprietary polyamide adhesive emulsion are added and the formulation is stirred at 1000 RPM for 30 minutes.

### EXAMPLE 15

The formulation of Example 9 is poured into the heated trough (45° C.) of a 3 bowl padding mangle. Nylon thread is continuously fed into the trough and is squeezed at about 1.2 bar. The thread is then transported to a drying oven operating at about 120 C and subsequently to a curing oven operating at 180° C. Upon exit, the thread is coated with a waxy emulsion using a kiss roll. The thread is then wound on a bobbin.

The process of Example 15 may be performed with the formulations of Examples 10-14 and combinations thereof.

The Table below lists some of the formulations of the present invention. The application and curing conditions were developed by changing the physical conditions (temperatures, squeeze pressures, line speed ) sequentially until an effective uniform dry add-on of up to 25% of untreated thread weight was achieved and good flame retardancy (pass TB 603) and good sewing performance (no thread breaks and no significant sloughing off of the FR finish) were obtained.

Drying at 120-180° C., curing at 180-230° C., 1.2 bar squeeze pressure, 50 meters/min line speed. Preferably, curing is in a forced air oven.

Surfactants that are suitable include polyoxyethylene alkylates and organic phosphate esters. Thickeners that are suitable include polyacrylic acids, polyacrylic acid esters, carboxylated and methylated cellulose, gum, alginate, chitosan, polysaccharides and polycrboxylic acid derivatives including esters, carboxylates and alkylates.

A preferred surfactant is Triton® X100 (Dow Chemical, Midland Mich.). A preferred thickener is polyacrylate thickener (Carbopol® 934 (The Lubrizol Corporation, Wickliffe, Ohio)

Preferred fluorocarbons include linear, branched and cyclic copolymers of fluoro substituted olefins ranging in molecular weight from 100 to 10,000 Daltons. A preferred fluorocarbon is Scotchgard® (3M).

Waxes include emulsions of polyethylene wax ranging in molecular weight from 100 to 1000 Daltons, emulsions of natural wax, emulsions of petroleum based paraffin, Silicone lubricant (Rayolan COKE, Dr. Th. Boehme). A preferred wax is polyethylene wax emulsion (Liquilube® 418, The Lubrizol Corporation, Wickliffe, Ohio)

The table below summarizes several formulations tested:

| | Formulation | | | | | | | |
|---|---|---|---|---|---|---|---|---|
| | 1 | 2 | 3 | 4 | 5 | 6 | 7 | 8 |
| | Wt. % | Wt. % | Wt. % | Wt. % | Wt. % | Wt. % | Wt. % | Wt. % |
| Water or | 8 | 20 | 65 | 60 | 60 | 75 | 75 | 80 |
| Solvent | | | | | | | | |
| FR | 90 | 70 | 30 | 30 | 30 | 20 | 20 | 15 |
| Surfactant | 0.2 | 0.2 | 0.2 | 0.3 | 0.3 | 0.3 | 0.2 | 0.2 |
| Thickener | 0.1 | 0.1 | 0.1 | 0.15 | 0.15 | 0.2 | 0.2 | 0.3 |
| Ammonia or | 0.1 | 0.1 | 0.1 | 0.1 | 0.1 | 0.1 | 0.1 | 0.1 |
| AA | | | | | | | | |
| Fluorocarbon | 0 | 2 | 0 | 2 | 0 | 0 | 2 | 2 |
| Wax | 2 | 0 | 0 | 0 | 2 | 0 | 0 | 0 |
| APO | 0 | 4.6 | 0 | 4.6 | 4.6 | 0 | 2 | 1 |
| APP | 0 | 0 | 2 | 2 | 2 | 0 | 1 | 2 |
| Other | bal. | bal. | bal. | bal. | bal. | bal. | bal. | bal. |

bal. = balance

APO is antimony pentoxide. APP is ammonium polyphosphate.

The formulation of the present invention is particular suitable for obtaining good coverage and adhesion on the smooth sewing thread and at the same time sufficient add-on. Traditional high viscosity/high solids formulations give high add-on values but tend to create clumps and uneven coating on a smooth thread.

On the other extreme, low viscosity/low solids content formulations create a continuous coating but are often very thin and insufficient add-on is the result.

A specific combination of solids content, viscosity, wetting efficiency, and mechanical action (squeezing pressure) is essential to obtain both good continuity and sufficient coverage.

In addition, rapid drying and curing will cause cracking and flaking of the coating while too slow drying and curing will allow the coating to run under gravity and create “bald spots” on the top part of the thread. Therefore it is the complex combination of formulation parameters and physical parameters of the processing line that allow the novel achievement of obtaining a thread evenly and sufficiently coated with a flame retardant formulation which can pass flame retardant testing and yet withstand the rigors of the sewing process. The unique TexFRon® FR agent helps in this regard because it is a smooth polymer emulsion with no suspended gritty particles. In this sense, the present invention has surprisingly found the TexFRon® FR agent to be especially suited or use on thin sewing threads where any grittiness is unacceptable. In the same manner, the aforementioned solvent soluble FR agents such as TBBA were also found be especially suited or use on thin sewing threads

The FR thread of the present invention must pass the sewing and FR tests discussed herein. Optimal coverage of FR coating on thread is not easily obtained. If coverage is insufficient, the thread will fail the FR test because it will ignite in the area of insufficient coverage, or “bald spot,” and tear. If the adhesion is poor or clumpy, the coating will typically flake off during sewing. The thread prepared according to the present inventive process and method passes the sewing and FR tests.

The process of the present invention is also advantageous because it is accomplished on a continuous basis. All textile finishing processes are divided into either batch or continuous processes.

In a batch process, a quantity of material is charged into a vessel in which a process is performed and subsequently the material is discharged, creating a discreet batch.

In a continuous process, a continuous stream of material is fed into one end of a processing line and is continuously collected on the other end. Dyeing and finishing processes can be done in both modes. Continuous processes have the advantage of greater productivity but lack flexibility for changes. For a process such as flame retardant treatment continuous process has a great advantage. The parallel in the batch mode would be to add the flame retardant to a processing vessel filled with thread, perform the application and subsequently discharge the vessel and recharge with a new batch. The batch-wise process is not efficient for thread production. The process of the present invention allows for continuous processing for polyester and nylon FR thread.

Flame Retardant Test Results

Formulation 1 was used for both samples. Sample A and sample B denote the mattresses tested.

Samples

The mattress samples evaluated are described in Table 1. The two mattresses were sewn with FR Polyester thread.

TABLE 1
Sample Description

| Sample Reference | Description |
|---|---|
| 1 | Model 100-914382 - Sample A |
| 2 | Model 100-914382 - Sample B |

Method:

The tests were conducted in accordance with the flammability test protocol outlined in the Consumer Product Safety Commission (CPSC) 16 CFR Part 1633—Standard for the Flammability (Open Flame) of Mattress Sets; Final Rule, dated Mar. 15, 2006.

An open calorimeter, Test Configuration A was used for this project. Under this test method, mattresses are exposed to an open flame ignition source. Test results include rate of heat release determinations.

Criteria:

Mattress set samples fail to meet the requirements of CPSC 16 CFR Part 1633 if any of the following criteria are exceeded:
1 ) A maximum heat release rate of 200 kW during the thirty-minute test.
2) A total heat release of 15 MJ in the first 10 minutes of the test.

Results:

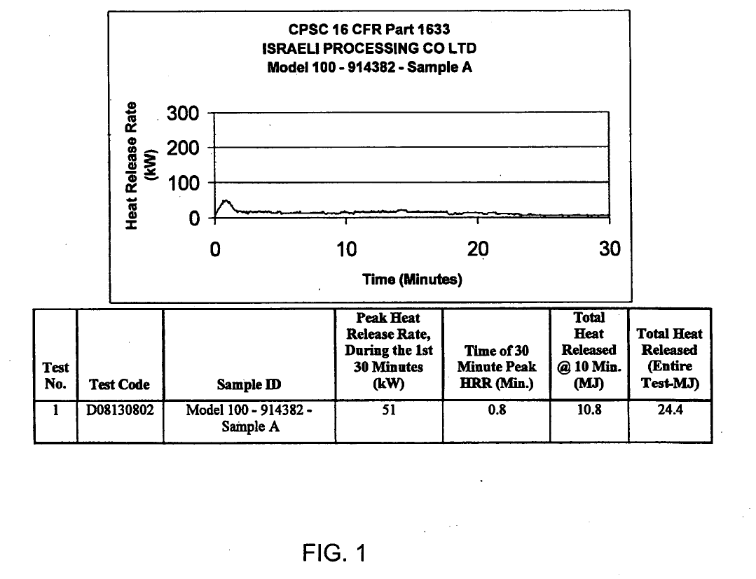

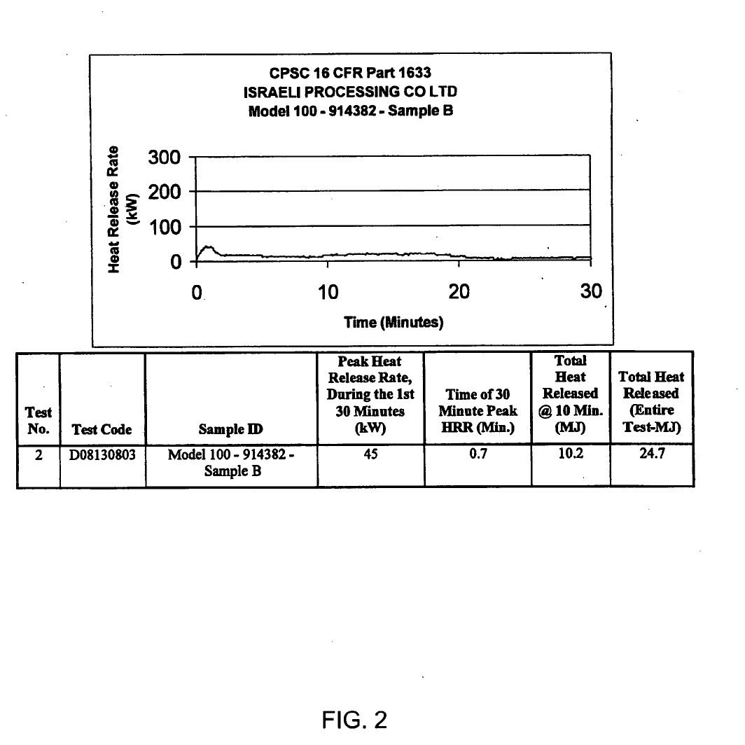

A summary of test results is tabulated below. Graphs of Heat Release Rate are provided as FIG. 1 and FIG. 2.

The test results relate only to the actual samples tested.

| | | | | Peak | | |
|---|---|---|---|---|---|---|
| | | | | Heat | | |
| | | | | Release | | |
| | | | | Rate, | Time to | |
| | | | | During | Peak | Total |
| | | | | the 1st | Heat | Heat |
| | | | | 30 | Release | Released |
| Test | | | Prototype | Minutes | Rate, | @ 10 Mm. |
| No. | Test Code | Sample ID | ID | (kW) | (min.) | (MJ) |
| 1 | D08130802 | ModellOO-914382 - | 914382 | 51 | 0.8 | 10.8 |
| | | Sample A | | | | |
| 2 | D08130803 | Model 100-914382 - | 914382 | 45 | 0.7 | 10.2 |
| | | Sample B | | | | |

Developmental Test Record

16 CFR Part 1633—Standard for the Flammability (Open Flame) of Mattress Sets

Sample ID: Model 100-914382 - Sample A
TYPE OF TEST ROOM
Configuration A - Open Calorimeter
ROOM CONDITIONS: Temperature 72° F.
% Relative Humidity 48
TIME OUT OF CONDITIONING ROOM: TEST START TIME
9:40:00 AM 9:46:25 AM
TEST DATA: Total Heat Release 10.8 MJ (within first 10
minutes)
Peak Heat Release Rate 51 kW
(within first 30 minutes)

Developmental Test Record

16 CFR Part 1633—Standard for the Flammability (Open Flame) of Mattress Sets

Sample ID: Model 100-914382 - Sample B
TEST FACILITY
UNDERWRITERS LABORATORIES INC.
333 PFINGSTEN ROAD
NORTHBROOK, ILLINOIS 60062
TYPE OF TEST ROOM
Configuration A - Open Calorimeter
ROOM CONDITIONS: Temperature 74° F.
% Relative Humidity 47
TIME OUT OF CONDITIONING ROOM: TEST START TIME
10:20:00 AM 10:27:03 AM
TEST DATA: Total Heat Release 10.2 MJ
(within first 10 minutes)
Peak Heat Release Rate 45 kW
(within first 30 minutes)

As seen by the results, the samples tested passed each test. Each of sample A and sample B were exhibited a heat release rate below the maximum heat release rate of 200 kW during the thirty-minute test. Also, each of sample A and sample B exhibited a total heat release of less than 15 MJ in the first 10 minutes of the test. Thus the samples prepared according to the present invention meet the desired criteria of the U.S. Consumer Product Safety Commission 16 CFR Part 1633—Standard for the Flammability.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

1. A fire retardant thread comprising:
a. an inner portion of sewing thread;
b. a fire retardant coating disposed on said sewing thread substantially completely covering said sewing thread, said coating comprising:
i. brominated acrylic copolymer;
ii. a non ionic surfactant;
iii. optionally, a thickening agent.

2. The fire retardant thread of claim 1 wherein said brominated acrylic copolymer is about 3-50% the weight of said thread.

3. The fire retardant thread of claim 1 wherein said non ionic surfactant is about 0.5-5% the weight of said thread.

4. The fire retardant thread of claim 1 further comprising synergists in the range of 1 to 15% based on the weight of the thread.

5. The fire retardant thread of claim 4 wherein said synergists are elemental base metals and compounds containing antimony, tin, boron, zinc and aluminum oxides, salts, insoluble phosphorous containing salts, ammonium polyphosphates, and combinations thereof.

6. The fire retardant thread of claim 1 wherein said thickening agents are acrylic acid derivatives, polysaccharide derivatives, or combinations thereof.

7. The fire retardant thread of claim 1 wherein a solution of said coating has a viscosity at 25° C. of about 20 to 2,000 cps.

8. The fire retardant thread of claim 1 wherein said sewing thread is polyester, polyolefin, or polyamide thread.

9. A fire retardant thread comprising:
a an inner portion of sewing thread;
b a fire retardant coating disposed on said sewing thread substantially completely covering said sewing thread, said coating comprising:
bromine or phosphorus based FR agent;
ii. polyamide based adhesive
iii. a non ionic surfactant;
iv. optionally, a thickening agent.

10. The fire retardant thread of claim 9 wherein said bromine or phosphorus based FR agent is about 2-50% the weight of said thread.

11. The fire retardant thread of claim 9 wherein said polyamide based adhesive is about 3-50% the weight of said thread.

12. The fire retardant thread of claim 9 wherein said non ionic surfactant is about 0.5-5% the weight of said thread.

13. The fire retardant thread of claim 9 further comprising synergists in the range of 1 to 15% based on the weight of the thread.

14. The fire retardant thread of claim 13 wherein said synergists are elemental base metals and compounds containing antimony, tin, boron, zinc and aluminum oxides, salts, insoluble phosphorous containing salts, ammonium polyphosphates, and combinations thereof.

15. The fire retardant thread of claim 9 wherein said thickening agents are acrylic acid derivatives, polysaccharide derivatives or combinations thereof.

16. The fire retardant thread of claim 9 wherein a solution of said coating has a viscosity at 25° C. of about 20 to 2,000 cps.

17. The fire retardant thread of claim 9 wherein said sewing thread is polyester, polyolefin, or polyamide thread.

18. A process for preparing fire retardant thread comprising the steps of:
obtaining sewing thread;
preparing a coating solution of brominated polyacrylic polymer or bromine or phosphorus based FR and adhesive and non ionic surfactant in a vessel;
passing said thread into a trough containing the coating solution;
removing the thread from the trough;
squeezing said thread until said thread has absorbed an amount of solution of about 20-250% by weight of said coating solution;
passing said thread through a drying oven at about 80° C. to 180° C.;
passing said thread through a curing oven set at about 110° C. to 260° C.;
winding said thread around a bobbin, after passing over a lick roll with lubricant.

19. The process of claim 18 wherein said sewing thread is polyester, polyolefin, or polyamide thread.

20. The process of claim 18 wherein said coating solution has a viscosity at 25° C. of about 20 to 2,000 cps.
